(19) United States
(12) Patent Application Publication
(10) Pub. No.: US 2006/0277306 A1
(43) Pub. Date: Dec. 7, 2006

(54) Apparatus and method for data extraction

(76) Inventors: Andrew Robert Milne, Edinburgh (GB); Graham McDermott, Livingston (GB); Gordon McPherson, Alloa (GB)

Correspondence Address: Paul D. Greeley;Ohlandt, Greeley, Ruggiero & Perle, L.L.P., 10th Floor, One Landmark Square, Stamford, CT, 06901-2682, US

(21) Appl. No.: 11/404,132

(22) Filed: Apr. 14, 2006

(30) Foreign Application Priority Data
Jun. 1, 2005 (GB) 0511111.7

(51) Int. Cl. G06F 15/173

(52) U.S. Cl. 709/226

(57) ABSTRACT

An apparatus and method for data extraction from data units comprising a device for managing the extraction and determining if the data unit is of a predetermined type that a client desires to collect data from. The data unit types further comprising information fields which relate to data within the data unit wherein the information fields can be uniquely identified by a numeric tag. The numeric tag allows the apparatus and method to be dynamically modified by a user.

### FIELD OF THE INVENTION

This invention relates to an apparatus and method for data extraction from message data units in a communications network and more particularly but not exclusively to data extraction in systems monitoring the communications network.

### DISCUSSION OF THE BACKGROUND ART

In modern switched telecommunications systems (in particular, modern PSTNs) it has become common practice to provide two related but separate network infrastructures: a bearer or transmission network for carrying end-user voice and data traffic, and a signalling network for controlling the setup and release of bearer channels through the bearer network in accordance with control signals transferred through the signalling network (sometimes known as out-of-band signalling). In practice, such signalling networks comprise high-speed computers interconnected by signalling links; computer programs control the computers to provide a set of operational and signalling functions in accordance with a standardised protocol. One example of such a signalling protocol is the Signalling System No. 7 (SS7), whether as specified by the CCITT, ANSI, ETSI (for GSM), Bellcore or similar body, such as a network being herein referred to as an SS7 network. The CCITT Signalling System Number 7 is specified in Recommendations Q.700-Q.716 CCITT Volume VI-Fascicle VI.7, Geneva 1989, ISBN 92-61-03511-6. SS7 networks are being extensively deployed for control of telephone and other data transmission networks and basically comprise various types of signalling points, namely, Signalling End Points (SEPs), for example an end office or local exchange, and Signalling Transfer Points (STPs) interconnected by signalling links, the SEPs being associated for example with respective Signalling Switching Points (SSPs) of the transmission network, and with Signalling Control Points (SCPs).

It is desirable to monitor telecommunications networks, to collect and correlate data for analysis; such data may be used to improve network performance or maybe used for billing purposes, although other applications are envisaged. It is further desirable to extract the information in a manner which allows a client to dynamically configure the data which is collected. It may also be desirable to provide a client with only a subset of the total data collected.

### SUMMARY OF THE INVENTION

The present invention therefore seeks to provide a method and apparatus for processing information from a communications network, which overcomes, or at least reduces the problems of the prior art.

According to a first aspect of the invention there is provided a method of data extraction from a data unit comprising:

receiving a signalling unit from a source of signalling units,

determining if the data unit matches a type in a predetermined list,

if the data unit matches a type in the predetermined list at least one predetermined information field, from which it is desired to collect data, is read from the list, wherein each information field is identifiable by a unique tag,

extracting information from the data unit, wherein the method of data extraction is determined from the unique tag.

Optionally the method of data extraction may further comprise: determining a format in which the data should be placed from a predetermined list.

Optionally the data unit may be a copy of a data unit traversing a communications network.

The method of data extraction wherein the method may further comprise determining if the data unit is of a second type wherein the second type is a subset of the first type.

Optionally either the first or second information type may be a protocol which the data unit complies with.

Optionally either the first or second information type may be an operation carried out on a communications network which the data unit carries information about.

Optionally the data unit received may be received from a probe on a communications network.

Optionally the data unit received may be received from a storage device wherein the data was previously collected from a communications network.

Optionally the data may be collected by a system monitoring the network.

Optionally the unique tag may be numeric.

Optionally the data unit may be a signalling unit, for example that used by SS7 systems.

According to a second aspect of the invention there is provided an apparatus for extracting data from a data unit comprising:

a management device for managing extraction of the data from the data unit coupled to a source of data units, such as those in a communications network, said management device being coupled

to a means for determining if the data unit is of a type that matches a predetermined type, wherein said means stores a list of predetermined data unit types which it is desired to collect information from,

said means further stores at least one information field associated with the data unit type, wherein it is desired to extract data from the information field and said information field is uniquely identifiable by a unique tag;

at least one means for extracting data from the data unit wherein the means used to extract the data is determined from the unique tag.

Optionally the apparatus for extracting data from a data unit may further comprise a means for determining the format in which the data should be placed.

Optionally the data unit is a copy of a data unit traversing a communications network.

Optionally the apparatus for extracting data may further comprise means for determining if the data unit is of a second type wherein the second type is a subset of the first type.

Optionally either the first or second information type is a protocol which the data unit complies with.

Optionally either the first or second information type is an operation carried out on a communications network which the data unit carries information about.

Optionally the data unit received may be received from a probe on a communications network.

Optionally the data unit received may be received from a storage device which has previously collected data, or cloned data, in the form of a data unit from a probe on a communications network.

Optionally the data may be collected by a system monitoring the network.

Optionally the unique tag is numeric.

Optionally the data unit may be a signalling unit, for example that used by SS7 systems.

According to a third aspect of the invention there is provided an apparatus for extracting data from a data unit, the apparatus comprising means for:
receiving a signalling unit from a source of signalling units,
determining if the data unit matches a type in a predetermined list, and,
if the data unit does match a type in the predetermined list, for reading at least
the apparatus being further operable for extracting information from the data

According to a fourth aspect of the invention there is provided an apparatus for extracting data from a data unit comprising means operable for:
managing extraction of the data from the data unit,
determining if the data unit is of a type that matches a predetermined type,
storing a list of predetermined data unit types,
storing at least one information field associated with each data unit type,
extracting data from the information field by reference to an identification tag.

### BRIEF DESCRIPTION OF THE DRAWINGS

One embodiment of the invention will now be more fully described, by way of example, with reference to the drawings, in which:

FIG. 1 shows a block diagram of a system incorporating the apparatus according to one embodiment of the present invention;

FIG. 2 shows a schematic flow chart of the operation of a first process carried out by the apparatus shown in FIG. 1.

### DETAILED DESCRIPTION OF THE PREFERRED EMBODIMENT

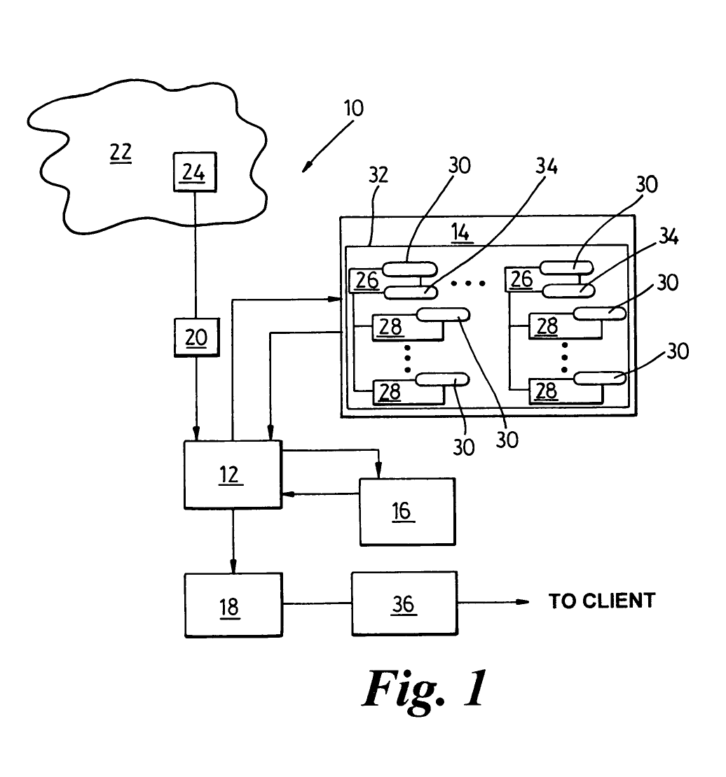

FIG. 1 shows a block diagram of a system 10 according to one embodiment of the present invention. FIG. 1 illustrates a communications network 22 which comprises a monitoring system that monitors the operation of the communications network 22. The monitoring system comprises a probe 24 which is coupled to the communications network 22; the probe 24 is also coupled to an extraction manager 12. The extraction manager 12 is coupled to a protocol manager 14, to a population visitor generator 16 and to a data extractor 18. Data output device 36 is coupled to the data extractor 18.

Monitoring of the communications network 22 is achieved using the probe 24. It will be appreciated that there could be multiple probes monitoring the communications network 22 and in practice on large communications networks this may be required if monitoring of the entire communications network 22 is desired. The probe 24 monitors the network traffic, information which travels the communications network 22 in the form of protocol data units (PDU) 20, an example of which is the Message Signalling Units (MSUs) used by SS7 systems. When the probe 24 detects a PDU 20 it clones, makes a copy of, the PDU 20 as it passes through the probe 24. The original PDU's 20 are allowed to continue on their journey on the communications network 22 to their specified destination. The cloning process allows the information held within the PDU's 20 to be obtained by the monitoring system without preventing normal operation of the communications network 22. Furthermore it minimizes the delay experienced by network traffic on the communications network 22 that may be caused by the introduction of the monitoring system to the communications network 22. Once the PDU 20 has been cloned it is desired to extract information from the cloned PDU's 20, however it will be obvious to those skilled in the art that the techniques described herein could be applied to the original PDU's 20 and therefore hereinafter no distinction will be made between original PDU's 20 and cloned PDU's 20.

In order to extract the information from the PDU 20, the PDU 20 enters an extraction manager 12. It will be appreciated that the extraction manager 12 may be a piece of hardware dedicated to managing extraction of information from PDU's 20 or may be one of a number of applications being handled by a hardware device. It will be further appreciated that cloned PDU's 20 could be collected from multiple probes 24 on the communications network 22 by a collection device (not shown) before they are processed by the extraction manager 12 or the PDU's 20 may be collected directly by the extraction manager 12.

The extraction manager 12 controls the process of extracting information from the PDU's 20, ensuring that all the parameters necessary to extract the desired information from a particular PDU 20 are known, it is also responsible for ensuring that all the information that it is desired to extract from an individual PDU is known.

When a PDU 20 is received by the extraction manager 12 it forwards to a protocol manager 14 a reference or a pointer to the PDU 20 received. This allows the protocol manager 14 to access the data in the PDU 20. In alternative embodiments it will be appreciated that the extraction manager 12 could forward a copy of the PDU 20 to the protocol manager 14. In a further alternative embodiment the actual PDU 20 collected by the extraction manager 12 could be forwarded to the protocol manager 14. The protocol manager 14 comprises a data storage medium such as an optical or magnetic disc, the data storage medium stores data which may be in the form of a list or database although other formats known in the art are also envisaged. Any PDU 20 on the communications network 22 will comply with a protocol. A protocol is a set of rules which the PDU 20 must adhere to and which control how the PDU 20 is processed by the communications network 22, for example the PDU 20 may comply with the luCS protocol. The PDU 20 will also relate to an operation of the communications network 22. The operation which the PDU 20 relates to is a task which is to be carried out the on the communications network 22, for example the operation may be to “set up a call” on the communications network 22 or to “terminate a call” on the communications network 22. It is possible for a PDU 20 to comprise or relate to more than one operation.

The protocol manager 14 stores a list 32, or alternatively a database 32, of protocols 26 and/or operations 28, that PDU's 20 existing on the communications network 22 may relate to. It is desired that the system 10 extracts information from PDU's 20 relating to protocols 26 and/or operations 28 contained in the list 32. In an alternative embodiment the protocol manager 14 could store a list of all possible protocols 26 and/or operations 28. It is envisaged that a client may pre-select information which they desire to collect from the communications network 22, by specifying particular protocols 26 and/or operations 28; for example a client may pre-select to collect information from all PDU's 20 on the communications network 22 which comply with the luCS protocol and/or operations which instruct the communications network 22 to terminate a call. This information would be stored by the protocol manager 14. It is envisaged that there may be multiple clients and that the protocol manager 14 would store all the protocols 26 and/or operations 28 for all the clients in the list or database 32. It is therefore envisaged that a client could select to collect all information extracted from the communications network 22, or a subset of the information collected, using the field identifiers 30 as references. The list 32 stored by the protocol manager 14 can be updated as the information requirements of the client/s change and/or to support new protocols 26 and/or operations 28 or if existing protocols 26 and/or operations 28 become obsolete. This may simply require a simple text file, listing all protocols and/or operations of interest, to be updated or edited; this would be a simple process introducing minimal disruption to the system 10, and furthermore would be simple to implement.

Associated with each protocol 26 and/or with each operation 28 stored in the list 32 is at least one information field from which it is desired to extract data from the PDU 20. It is not necessary that there must be an information field associated with both a protocol 26 and an operation 28. In some instances it may only be desired to collect information regarding a specific protocol 26 or operation 28. It is also possible that no information fields are associated with both a protocol 26 and an operation 28, however in this case no information would be gathered from a PDU 20.

Each information field is given a unique tag, known as field identifier 30; this makes it possible to identify the information field that pertains to a particular protocol 26 or operation 28. In one embodiment the unique tags, field identifiers 30, are numeric however it is envisaged that other character strings such as text could be used, or that alpha-numeric strings could be utilised.

The information field is a description of, or the type of, information which the client desires to collect, for example the information field may be an Originating Point Code (OPC), a Destination Point Code (DPC) or a Circuit Identification Code (CIC). A point code is a unique identifier, sometimes called the ‘address’ of a piece of network equipment. The address typically may take the form of an ANSI point code, a 24 bit number in three octets, where an octet is an 8 bit number which can take the decimal values 0 to 255. The point code in decimal form appears as, XXX.XXX.XXX, where XXX signifies an octet each octet comprising a named network, cluster and member respectively. As an example the information field may be the originating point code whilst the data held in this field, the 8 bit number, identifying a piece of hardware in the communication network 22, would be the data which the client desires to collect.

Upon receipt of a pointer to a PDU 20, or of an actual PDU 20, the protocol manager 14 checks to see if the PDU 20 complies with one of the protocols 26 stored in the list 32. It is envisaged that the protocol manager 14 will compare the PDU 20 against each of the protocols 26 in the list or database 32 in turn, until it finds a match or reaches the end of the list or database 32, however other search methods known in the art could be employed.

If the protocol manager 14 finds a match it then searches through a list of operations 28 associated with each protocol 26 of which it is desired to collect information. It is possible for a PDU 20 to comprise or relate to more than one operation, in such a case the protocol manager 14 will determine if any of the operations in the PDU 20 match with any of the operations contained within the list of operations 28.

Upon completion of the comparison of the PDU 20 with the list of operations 28, the protocol manager 14 returns to the extraction manager 12 a list of the field identifiers 30 of any protocol 26 and/or operation 28 that match the PDU 20 which it has found. This instructs the extraction manager 12 which information fields the client wishes to collect information from. In alternative embodiments where the extraction manager 12 does not retain the original, or a copy of, the PDU 20, then the protocol manager 14 may also return the PDU 20 to the extraction manager 12.

In addition to the list of information fields and their respective field identifiers 30, the protocol manager 14 may also store a data format 34 or plurality of data formats 34 with each protocol 26. It is envisaged that multiple data formats 34 will be associated with each protocol 26 as the, or each, client may require the same information in different formats. The data format 34 informs the extraction manager 12 the format in which the extracted data should be placed, for example the data format 34 maybe in the form of “comma separated values”, where each data value is separated by a comma. Other data formats as known in the art are also envisaged, without departing from the scope of the invention. In some embodiments it may be desired to use different data formats for different protocols 26.

If no matching protocols 26 and/or operations 28 are found then the extraction manager 12 discards the current PDU 20 and waits for receipt of a further PDU 20 or in the alternative may request a PDU 20 from the probe 24.

When the extraction manager 12 receives a data format 34 from the protocol manager 14, it requests the population visitor generator 16 to create a population visitor for each data format 34 received. The population visitors created by the population visitor generator 16 are returned to the extraction manager 12. The population visitors comprise instructions regarding the format in which the extracted data should be published.

The extraction manager 12 then passes to the data extractor 18; the PDU 20, a list of the field identifiers 30 of the matching the protocol 26, field identifiers 30 of any matching operations 28 and any population visitors relevant to the PDU 20.

The data extractor 18 comprises at least one means for extracting information from the PDU 20. In alternative embodiments the data extractor 18 may comprise multiple means for extracting information from the PDU 20. When multiple extraction means are available the extraction means used may depend upon the information which is to be extracted. The data extractor 18 could determine which extraction means should be used to extract information from the PDU from the field identifier 30 for the respective information field. When multiple extraction means are possible the data extractor will retain information which instructs the data extractor 18 which means of extraction should be used for a particular field identifier 30, again this information could be stored by the data extractor 18 a list or a database on a storage medium known in the art or held in memory.

The data extractor 18 extracts data from the desired information fields in the PDU and then passes the field identifier 30 and the extracted data to each population visitor created by the population visitor generator 16.

Once all data has been extracted from all the desired information fields and passed to the population visitors. The data output device 36 uses the population visitors to consolidate the extracted data (if needed) and pass it on to the relevant client.

The population visitors act as an intermediary stage between the data in the PDU's 20 to be extracted by extraction apparatus, comprising the extraction manager 12 and data extractor 18, and data published to the client.

Each field identifier 30 listed for extraction, whether relating to a protocol 26 or an operation 28, is passed to each population visitor in turn. The population visitors also receive the extracted data corresponding to the field identifier 30. The population visitor place the extracted data in to whatever format it was created to produce, the extraction apparatus may pass extracted data, field identifiers 30 to multiple different population visitors each created to produce data in a different format.

Once the extraction manager has extracted all of the data desired, i.e. all of the data corresponding to each of the field identifiers 30 in the list 32, it will instruct each of the population visitors that it has finished sending data to them and that the population visitors should consolidate the data it contains. An example of a task done carried out by a population visitor would be to finalise the structure/s of the data and pass it/them on to a client. One such data structure may be a call data record (CDR) builder structure, used in “access7” systems the information could then be passed to and read by a CDR system.

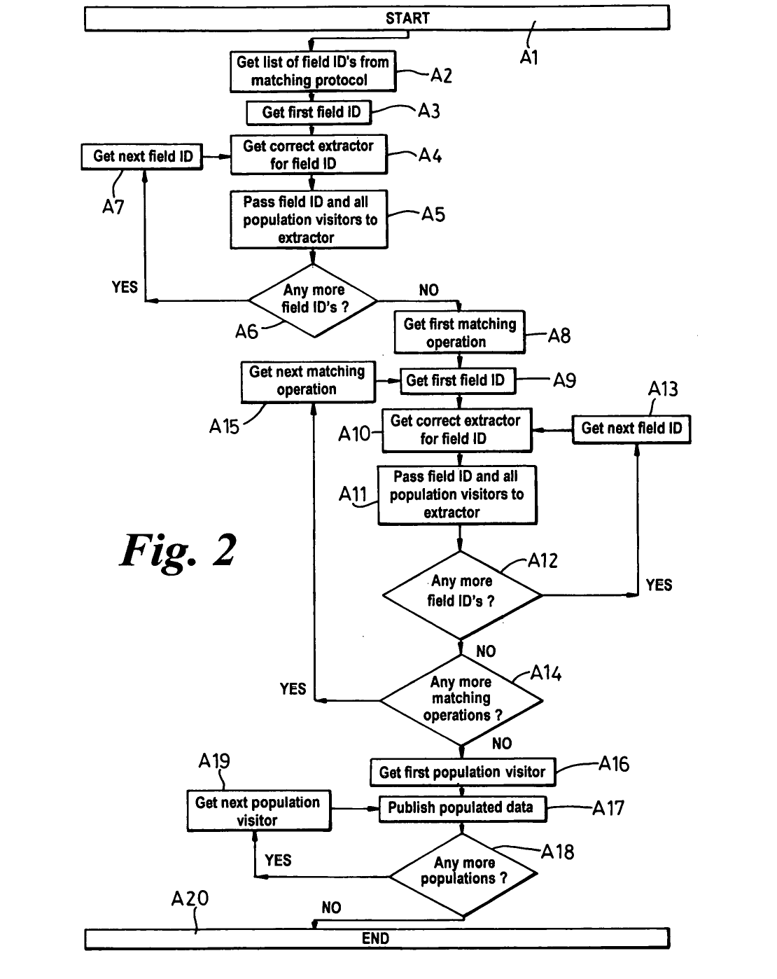

The process of data extraction will be further described by reference to FIG. 2 which shows a schematic flow chart of the operation of the data extractor 18.

The data extractor 18 executes the “data extraction” process as described below:
A1—Data Extraction starts with the data extractor 18 receiving from the extraction manager 12; the PDU 20, a list of field identifiers 30 of the matching the protocols 26 and the matching operations 28 of which data should be collected and any population visitors created by the population visitor generator 16. This is followed by A2
A2—This follows execution of A1. The data extractor 18 gets the list 32 of field identifiers 30 that pertain to the matching protocols 26 that have been received from the extraction manager 12. A3 follows from execution of A2.
A3—This follows execution of A2. The data extractor 18 calls up the first field identifier 30 in the list 32 received from the extraction manager 12. This is automatically followed by A4.
A4—This follows execution of A3. The data extractor 18 determines which means of extraction should be used to extract the information from the PDU 20. The data extractor 18 will determine the appropriate means of extraction from the field identifier 30. A5 follows execution of A4.
A5—This follows execution of A4. The field identifier 30 from A4 is passed on to the means of extraction determined in A4, any population visitors associated with the field identifier 30 being passed are also passed to the means of extraction. The means of extraction will extract the information from the PDU 20. A6 follows execution of A5.
A6—This follows from A5. The data extractor 18 determines if there are any more field identifiers 30 in the list received from the extraction manager 12 in A1 which require processing. This block determines if there are any more information fields associated with the protocol that need to be extracted. If there are further field identifiers 30 in the list then A7 is executed, if there are not any more field identifiers 30 in the list then A8 is executed.
A7—This follows a positive result from the test in A6. The data extractor 18 gets the next field identifier 30 from the list received from the extraction manager 12 in A1. A4 follows execution of A7.
A8—This follows a negative result from the test in A6. The data extractor 18 gets the first matching operation 28 from the list received from the extraction manager 12 in A1. A9 follows execution of A8.
A9—This follows execution of A8. The data extractor 18 gets the first field identifier 30 associated with the matching operation 28 being processed. A10 follows execution of A9.
A10—This follows execution of A9. The data extractor 18 determines which means of extraction should be used to extract the information from the relevant information field in the PDU 20. The data extractor 18 will determine the appropriate means of extraction using the field identifier 30. A11 follows execution of A10.
A11 —This follows execution of A10. The field identifier 30 from A10 is passed on to the means of extraction, determined in A10. The PDU 20 and any population visitors associated with the field identifier 30 being passed are also passed to the means of extraction. The means of extraction will extract the field data or information, from the PDU 20. The means of extraction passes the field identifier 30 and the information extracted from the information field to each population visitor. A12 follows execution of A11.
A12—This follows from A11. The data extractor 18 determines if there are any more field identifiers 30 in the list received from the extraction manager 12 in A1. If there are further field identifiers 30 in the list then A13 is executed, if there are not any more field identifiers 30 in the list then A14 is executed.
A13—This follows a positive result from the test in A12. The data extractor 18 gets the next field identifier 30 from the list received from the extraction manager 12 in A1. A10 follows execution of A13.
A14—This follows a negative result from the test in A12. The data extractor 18 determines if there are any more matching operations 28 in the list received from the extraction manager 12 in A1. If there are further matching operations 28 in the list then A15 is executed, if there are not any more matching operations 28 in the list then A16 is executed.
A15—This follows a positive result from the test in A14. The data extractor 18 gets the next matching operations 28 from the list received from the extraction manager 12 in A1. A9 follows execution of A15.
   A16-A20 are executed when all the field data or information as been extracted from the PDU.
A16—This follows a negative result from the test in A14. The data output device 36 calls the first population visitor received from the extraction manager 12. At this point the extraction process is complete, the data extractor 18 has extracted all the information that it is desired to extract from the particular PDU 20 being processed by the extraction manager 12. The process of formatting the extracted data into the form/s required by the client/s begins. This formatting process could be performed by alternative device in the system 10. A17 follows execution of A16.
A17—This follows execution of A17. The current population visitor, which comprises; the extracted data and the field identifiers 30, determines how the complete set of data extracted should be processed. This places the data in the form specified. The data is published to the client/s upon completion of the translation of the data into the desired format. A18 follows execution of A17.
A18—This follows execution of A17. The data output device 36 determines if there are further population visitors in the list received from the extraction manager 12 in A1. If there are further population visitors in the list then A19 is executed, if there are not any more population visitors in the list then A20 is executed.
A19—This follows a positive result from the test in A18. The data output device 36 gets the next population visitors from the list received from the extraction manager 12 in A1. A17 follows execution of A19.
A20—This follows a negative result from the test in A18. The process of data extraction is complete; the data has been published into all the desired formats the data is output from the data output device 36 to the client/s. The extraction manager 12 can receive a further PDU 20 from the probe 24 and begin to process it; the extraction manager sends the PDU 20 to the protocol manager 14 for comparison with the list 32 of protocols 26 and or operations 28.

The use of the numeric tag to identify the information fields allows the information to be configured dynamically. The list of protocols and operations held by the protocol manager 14 can be updated, this allows the new protocols or operations to be monitored and the information from them collected with substantial changes to the system by allowing generic coding, the same methods can be used regardless of the information field 30 that is being processed. The reference data held by the protocol manager 14 may be configured by a user.

The process of comparison of the PDU 20 with the reference data held by the protocol manager 14 may be achieved using a filter which allows the protocol manager to identify if a signalling unit 20 is appropriate to a particular protocol 26 or operation 28.

When multiple clients require information from the system 10 the system will collect all the information fields requested by all the clients. The client may then be supplied with the complete data extracted by the system 10 or just the information fields 30 that were requested. It is probable that this will be determined by the resources available for distributing the data to the client: for example for a remote client coupled to the system 10 on a low bandwidth connection it may be preferable to supply just the information requested.

Whilst it is envisaged that the present invention will be utilized in real-time, when the system monitoring the network is carrying out its monitoring function: it is envisaged that the extraction process could be carried out off-line. That the data in the form of PDU's 20 may be collected by cloning the PDU's 20 and storing or arching them for processing at a later date.

What is claimed is:

1. A method of data extraction from a data unit comprising:
receiving a signalling unit from a source of signalling units,
determining if the data unit matches a type in a predetermined list,
if the data unit matches a type in the predetermined list at least one predetermined information field, from which it is desired to collect data, is read from the list, wherein each information field is identifiable by a unique tag,
extracting information from the data unit, wherein the method of data extraction is determined from the unique tag.

2. A method of data extraction according to claim 1 further comprising:
determining a format in which the data should be placed from a predetermined list.

3. A method of data extraction according to claim 1 wherein the data unit is a copy of a data unit traversing a communications network.

4. A method of data extraction according to claim 1 wherein there further comprises determining if the data unit is of a second type wherein the second type is a subset of the first type.

5. A method of data extraction according to claim 1 wherein either the first or second information type is a protocol which the data unit complies with.

6. A method of data extraction according to claim 1 wherein either the first or second information type is an operation carried out on a communications network which the data unit carries information about.

7. A method of data extraction according to claim 1 wherein the data unit received is received from a probe on a communications network.

8. A method of data extraction according to claim 1 wherein the data unit received is received from a storage device wherein the data was previously collected from a communications network.

9. A method of data extraction according to claim 7 wherein the data is collected by a system monitoring the network.

10. A method of data extraction according to claim 1 wherein the unique tag is numeric.

11. A method of data extraction according to claim 1 wherein the data unit is a signalling unit.

12. An apparatus for extracting data from a data unit comprising:
a management device for managing extraction of the data from the data unit coupled to a source of data units, said management device being coupled to a means for determining if the data unit is of a type that matches a predetermined type, wherein said means stores a list of predetermined data unit types which it is desired to collect information from,
said means further stores at least one information field associated with the data unit type, wherein it is desired to extract data from the information field and said information field is uniquely identifiable by a unique tag;
at least one means for extracting data from the data unit wherein the means used to extract the data is determined from the unique tag.

13. An apparatus for extracting data from a data unit according to claim 12 further comprising a means for determining the format in which the data should be placed.

14. An apparatus for extracting data from a data unit according to claim 12 wherein the signalling unit is a copy of a data unit traversing a communications network.

15. An apparatus for extracting data from a data unit according to claim 12 further comprising means for determining if the data unit is of a second type wherein the second type is a subset of the first type.

16. An apparatus for extracting data from a data unit according to claim 12 wherein either the first or second information type is a protocol which the data unit complies with.

17. An apparatus for extracting data from a data unit according to claim 12 wherein either the first or second information type is an operation carried out on a communications network which the data unit carries information about.

18. An apparatus for extracting data from a data unit according to claim 12 wherein the signalling unit received is received from a probe on a communications network.

19. An apparatus for extracting data from a data unit according to claim 12 wherein the signalling unit received is received from a storage device which has previously collected data, or cloned data, in the form of a data unit from a probe on a communications network.

20. An apparatus for extracting data from a signalling unit according to claim 17 wherein the data is collected by a system monitoring the network.

21. An apparatus for extracting data from a signalling unit according to claim 12 wherein the unique tag is numeric.

22. A apparatus for extracting data from a signalling unit according to claim 12 wherein the data unit is a signalling unit.

23. An apparatus for extracting data from a data unit, the apparatus comprising means for:
receiving a signalling unit from a source of signalling units,
determining if the data unit matches a type in a predetermined list, and,
if the data unit does match a type in the predetermined list, for reading at least one predetermined information field from the list, said at least one predetermined information field being a field from which it is desired to collect data and being identifiable by a unique tag,
the apparatus being further operable for extracting information from the data unit by reference to the unique tag.

24. An apparatus for extracting data from a data unit comprising means operable for:
managing extraction of the data from the data unit,
determining if the data unit is of a type that matches a predetermined type,
storing a list of predetermined data unit types,
storing at least one information field associated with each data unit type,
extracting data from the information field by reference to an identification tag.
